(19) United States
(12) Patent Application Publication
(10) Pub. No.: US 2006/0007200 A1
(43) Pub. Date: Jan. 12, 2006

(54) Method and system for displaying a sequence of image frames

(76) Inventors: David Young, Austin, TX (US); Oskar Pelc, Even Yehuda (IL)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/887,131

(22) Filed: Jul. 8, 2004

(51) Int. Cl. G09G 5/00

(52) U.S. Cl. 345/204

(57) ABSTRACT

A system and method for displaying a sequence of image frames, the system includes: (i) a first circuitry, adapted to receive a sequence of image frames at an update rate (Ur), the sequence of image frames is associated with a sequence of update synchronization signals; and (ii) a second circuitry, adapted to control a display the sequence of images at a refresh rate (Rr), whereas Rr=Ur*[(N+1)/N]; whereas the sequence of images are associated with a sequence of refresh synchronization signals that driven from the update synchronization signals. The method includes: (i) receiving a sequence of image frames at an update rate (Ur), the sequence of image frames is associated with a sequence of update synchronization signals; and (ii) displaying the sequence of images at a refresh rate (Rr), whereas Rr=Ur*[(N+1)/N]; whereas the sequence of images are associated with a sequence of refresh synchronization signals that driven from the update synchronization signals.

### FIELD OF THE INVENTION

The present invention relates to methods and systems for displaying a sequence of image frames and especially for preventing image tearing in a system in which a refresh rate is higher than an update rate.

### BACKGROUND OF THE INVENTION

Image tearing occurs in various occasions, and typically when asynchronous read and write operations are made to a shared image memory.

U.S. Pat. No. 6,489,933 of Ishibashi, et al., titled “Display controller with motion picture display function, computer system, and motion picture display control method”, which is incorporated herein by reference, describes a VGA controller that has a pass through mode and VRAM mode as motion picture display modes, and one of these display modes can be selected by controlling a switch. In the pass through mode, video data input from a video port interface can be directly output to an NTSC/PAL encoder without the intervention of a VRAM. In this mode, original video data can be displayed on a TV with its original quality. On the other hand, in the VRAM mode, the refresh rate for screen display is matched with the vertical sync frequency of video data, and a high-quality image free from any “tearing” can be obtained.

U.S. Pat. No. 6,054,980 of Eglit, titled “Display unit displaying images at a refresh rate less than the rate at which the images are encoded in a received display signal” which is incorporated herein by reference, describes a display unit receiving a display signal having source image frames encoded at an encoding rate (FRs). A display screen may be refreshed at a refresh rate which is less than the encoding rate. An actual refresh rate (FRd) is determined such that FRs/FRd=(N+1)/N. To satisfy this equation, the actual refresh rate (FRd) may be selected to be slightly different from the target refresh rate supported by the display screen. Pixel data elements representing source image frames (received at FRs) may be written into a frame buffer, and the pixel data elements may be retrieved at a frequency determined by refresh rate FRd. However, at least a part of every (N+1)'st source image frame is not written into the frame buffer to avoid image tearing problems.

U.S. patent application 20020021300 of Matsushita, titled “Image processing apparatus and method of the same, and display apparatus using the image processing apparatus”, which is incorporated herein by reference, describes an image processing apparatus and method of the same, and a display apparatus capable of avoiding occurrence of field tearing (memory overrun) even when performing a read operation and a write operation of input/output images with respect to a single image memory, wherein provision is made of a system MC for generating and supplying output delay data for delaying an image output timing based on the write speed to the image memory, the read speed from the image memory, and the read area so that the timing of access to the read end address (or the timing of access to the read start address) and the timing for performing a write operation to the same address match and of a scan converter for receiving the output delay data supplied by the system MC and delaying the image output timing so that the timing of access to the read end address and the timing for performing a write operation to the same address match.

There is a need to provide an efficient system and method for preventing tearing, especially when the refresh rate exceeds the update rate.

### SUMMARY OF THE PRESENT INVENTION

A system and method for preventing image tearing where an update rate of an image frame is lower that a refresh rate of the image frame. Conveniently, the method and system prevent image tearing by using a single frame buffer instead of a double framer buffer.

The system can be included within a system on a chip and can conveniently include an image processing unit that is connected to main processing unit.

A system for displaying a sequence of image frames, the system includes: (i) a first circuitry, adapted to receive a sequence of image frames at an update rate (Ur), the sequence of image frames is associated with a sequence of update synchronization signals; and (ii) a second circuitry, adapted to control a display the sequence of images at a refresh rate (Rr), whereas Rr=Ur*[(N+1)/N]; whereas the sequence of images are associated with a sequence of refresh synchronization signals that driven from the update synchronization signals.

A method for displaying a sequence of image frames, the method includes: (i) receiving a sequence of image frames at an update rate (Ur), the sequence of image frames is associated with a sequence of update synchronization signals; and (ii) displaying the sequence of images at a refresh rate (Rr), whereas Rr=Ur*[(N+1)/N] and whereas the sequence of images are associated with a sequence of refresh synchronization signals that driven from the update synchronization signals.

### BRIEF DESCRIPTION OF THE DRAWINGS

The present invention will be understood and appreciated more fully from the following detailed description taken in conjunction with the drawings in which:

FIG. 1 is a schematic diagram of a system on chip, according to an embodiment of the invention;

FIG. 2 is a schematic diagram of an asynchronous display controller, according to an embodiment of the invention;

FIG. 3 illustrates an exemplary display frame that includes two windows, according to an embodiment of the invention;

FIG. 4a-4b illustrate two types of access channels, according to various embodiments of the invention;

FIG. 5 illustrates a third type access channel, according to an embodiment of the invention

FIG. 6 illustrates a method for displaying a sequence of image frames, according to an embodiment of the invention; and

FIG. 7-8 are timing diagram illustrating the progress of image frame updates and refresh processes where N=1, according to various embodiment of the invention.

### DETAILED DESCRIPTION OF PREFERRED EMBODIMENT

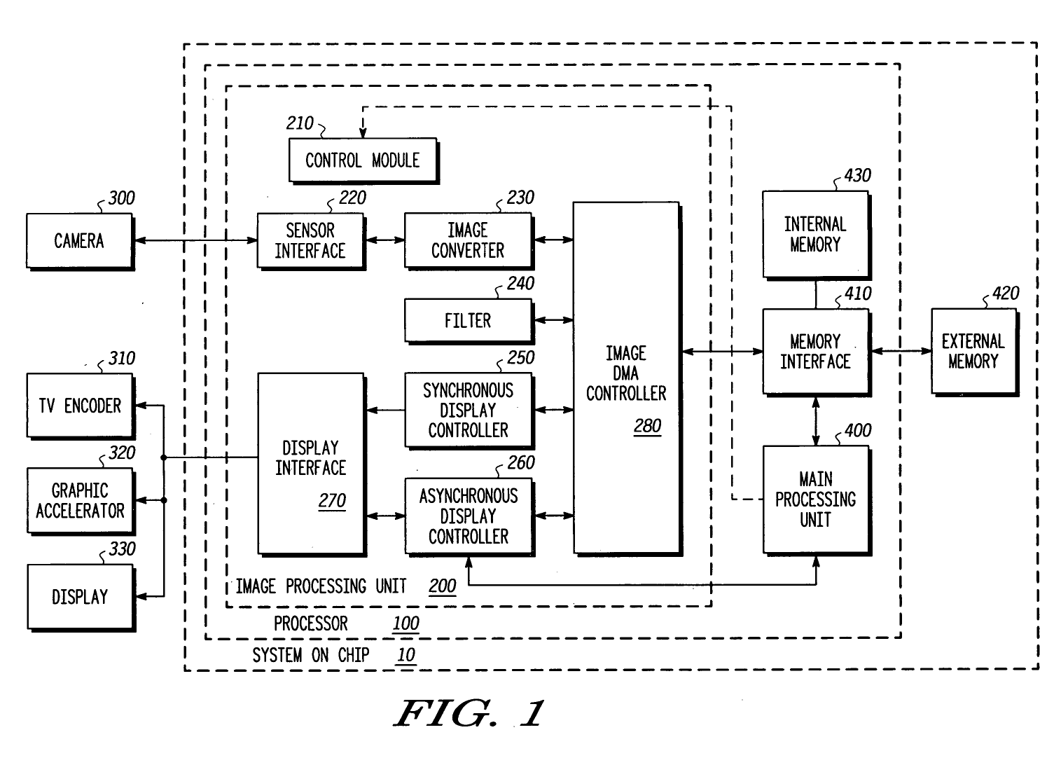

FIG. 1 illustrates a system on chip 10 that includes an external memory 420, processor 100 and an image-processing unit (IPU) 200. The processor 100 includes the IPU 200 as well as a main processing unit 400. Main processing unit 400 (also known as “general purpose processor”, “digital signal processor” or just “processor”) is capable of executing instructions.

The system on chip 10 can be installed within a cellular phone or other personal data accessory and facilitate multimedia applications.

The IPU 200 is characterized by a low energy consumption level in comparison to the main processing unit 400, and is capable of performing multiple tasks without involving the main processing unit 400. The IPU 200 can access various memories by utilizing its own image Direct Memory Access controller (IDMAC) 280, can support multiple displays of various types (synchronous and asynchronous, having serial interfaces or parallel interfaces), and control and timing capabilities that allow, for example, displaying image frames while preventing image tearing.

The IPU 200 reduces the power consumption of the system on chip 10 by independently controlling repetitive operations (such as display refresh, image capture) that may be repeated over long time periods, while allowing the main processing unit 400 to enter an idle mode or manage other tasks. In some cases the main processing unit 400 participates in the image processing stages (for example if image encoding is required), but this is not necessarily so.

The IPU 200 components can be utilized for various purposes. For example, the IDMAC 280 is used for video capturing, image processing and data transfer to display. The IPU 200 includes an image converter 230 capable of processing image frames from a camera 300, from an internal memory 430 or an external memory 420.

The system on chip 10 includes multiple components, as well as multiple instruction, control and data buses. For simplicity of explanation only major data buses as well as a single instruction bus are shown.

According to various embodiment of the invention the IPU 200 is capable of performing various image processing operations, and interfacing with various external devices, such as image sensors, camera, displays, encoders and the like. The IPU 200 is much smaller than the main processing unit 400 and consumes less power.

The IPU 200 has a hardware filter 240 that is capable of performing various filtering operations such as deblocking filtering, de-ringing filtering and the like. Various prior art methods for performing said filtering operations are known in the art and require no additional explanation.

By performing deblocking filtering operation by filter 240, instead of main processing unit 400, the IPU 200 reduces the computational load on the main processing unit 400. In one operational mode the filter 240 can speed up the image processing process by operating in parallel to the main processing unit 400.

IPU 200 includes control module 210, sensor interface 220, image converter 230, filter 240, IDMAC 280, synchronous display controller 250, asynchronous display controller 260, and display interface 270.

The IPU 200 has a first circuitry that may include at least the sensor interface 220, but may also include additional components such as IDMAC 280. The first circuitry is adapted to receive a sequence of image frames at an update rate (Ur). The IPU 200 also includes a second circuitry that may include at least the asynchronous display controller 260. The second circuitry is adapted to control the display of the sequence of images at a refresh rate (Rr), whereas Rr=Ur*[(N+1)/N].

The sensor interface 220 is connected on one side to an image sensor such as camera 300 and on the other side is connected to the image converter 230. The display interface 270 is connected to the synchronous display controller (SDC) 250 and in parallel to the asynchronous display controller (ADC) 260. The display interface 270 is adapted to be connected to multiple devices such as but not limited to TV encoder 310, graphic accelerator 320 and display 330.

The IDMAC 280 facilitates access of various IPU 200 modules to memory banks such as the internal memory 430 and the external memory 420. The IDMAC 280 is connected to on one hand to the image converter 230, filter 240, SDC 250 and ADC 260 and on the other hand is connected to memory interface 410. The memory interface 410 is be connected to internal memory 430 and additional or alternatively, to an external memory 420.

The sensor interface 220 captures image data from camera 300 or from a TV decoder (not shown). The captured image data is arranges as image frames and can be sent to the image converter 230 for preprocessing or post processing, but the captured data image can also be sent without applying either of these operations to IDMAC 280 that in turn sends it, via memory interface 410 to internal memory 430 or external memory 420.

The image converter 230 is capable of preprocessing image data from the sensor interface 220 or post-processing image data retrieved from the external memory 420 or the internal memory 430. The preprocessing operations, as well as the post-processing operations include downsizing, resizing, color space conversion (for example YUV to RGB, RGB to YUV, YUV to another YUV), image rotation, up/down and left/right flipping of an image and also combining a video image with graphics.

The display interface 270 is capable of arbitrating access to multiple displays using a time multiplexing scheme. It converts image data form SDC 250, ADC 260 and the main processing unit 400 to a format suitable to the displays that are connected to it. It is also adapted to generate control and timing signals and to provide them to the displays.

The SDC 250 supports displaying video and graphics on synchronous displays such as dumb displays and memory-less displays, as well on televisions (through TV encoders). The ADC 260 supports displaying video and graphics on smart displays.

The IDMAC 280 has multiple DMA channels and manages access to the internal and external memories 430 and 420.

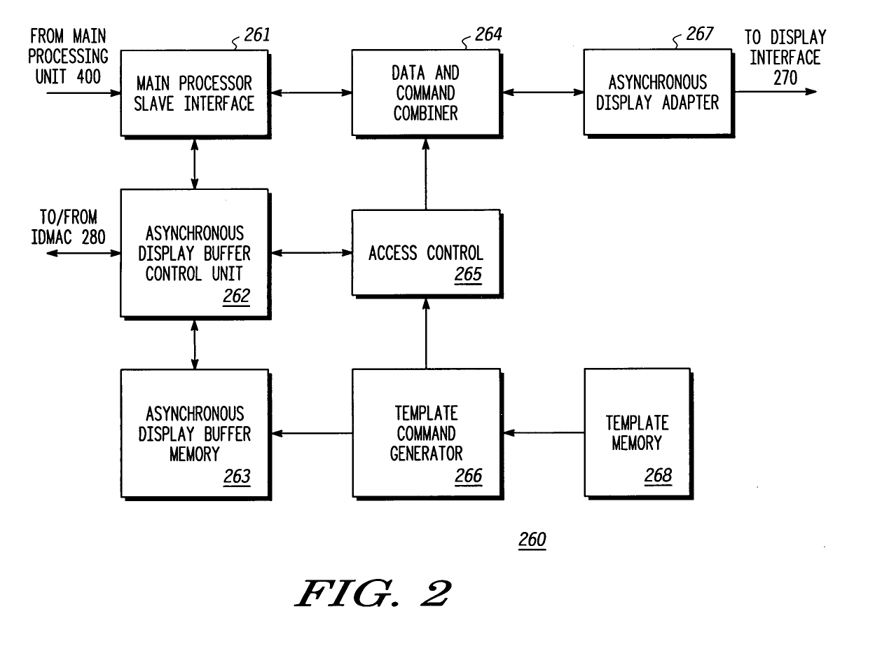

FIG. 2 is a schematic diagram of the ADC 260, according to an embodiment of the invention.

ADC 260 includes a main processing unit slave interface 261 that is connected to a main processing unit bus on one hand and to an asynchronous display buffer control unit (ADCU) 262. The ADCU 262 is also connected to an asynchronous display buffer memory (ADM) 263, to a data and command combiner (combiner) 264 and to an access control unit 265. The combiner 624 is connected to an asynchronous display adapted 267 and to the access control 265. The access control 265 is also connected to a template command generator 266 that in turn is connected to a template memory 268.

ADC 260 can receive image data from three sources: the main processing unit 400 (via the main processing unit slave interface 261), internal or external memories 430 and 420 (via IDMAC 280 and ADCU 262), or from camera 300 (via sensor interface 220, IDMAC 280 and ADCU 262).

ADC 260 sends image data, image commands and refresh synchronization signals to asynchronous displays such as display 330. The image commands can include read/write commands, addresses, vertical delay, horizontal delay and the like. Each image data unit (such as an image data word, byte; long-word and the like) can be associated with a command. The ADC 260 can support X,Y addressing or full linear addressing. The commands can be retrieved from a command buffer (not shown) or provided by the template command generator 266 from the template memory 268. The commands are combined with image data by the data and command combiner 264. A template includes a sequence of commands written to the template memory 268 by the main processing unit 400 that is executed every time a data burst is sent to (or read from) a smart display.

ADC 260 is capable of supporting up to five windows on different displays by maintaining up to five access channels. Two system channels enable displaying images stored within the internal or external memories 420 and 430. Another channel allows displaying images provided by the main processing unit. Two additional channels allow displaying images from camera 300 (without being processed or after preprocessing).

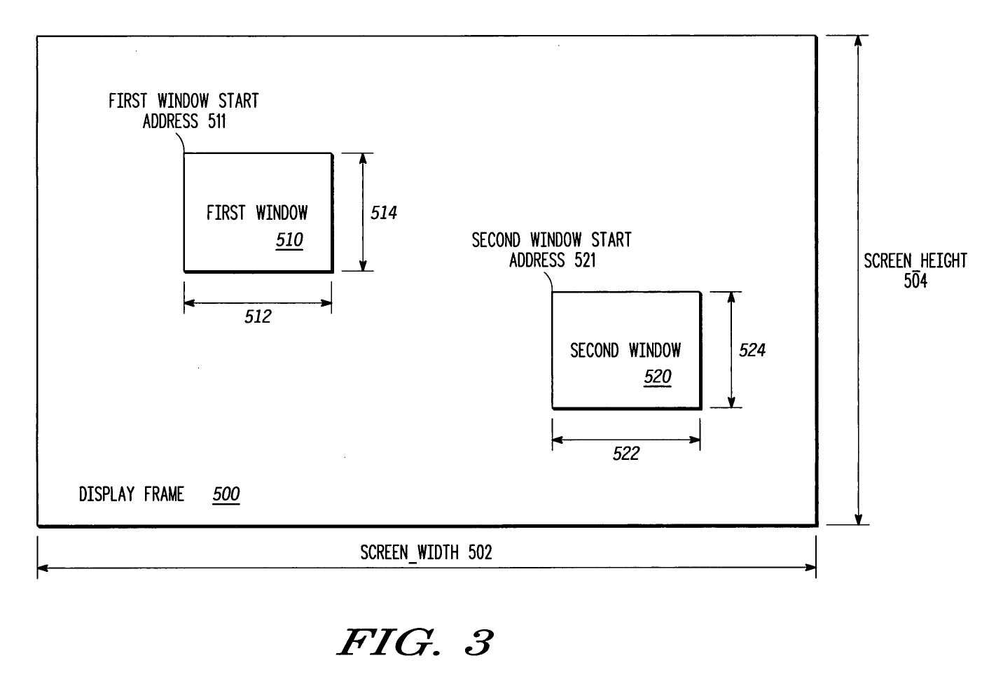

Each window can be characterized by its length width and its start address. The start address of each window is stored in a register accessible by the ADC 260 and conveniently refers to a refresh synchronization signal such as VSYNCr. The start address resembles a delay between the VSYNCr pulse and the beginning of the frame. FIG. 3 illustrates an exemplary display frame 500 that includes two windows 510 and 520, according to an embodiment of the invention. The display frame 500 has a start address that is accessed when a VSYNCr pulse is generated. The first window 510 has a start address 511 that corresponds to a predefined delay after the VSYNCr pulse. The display frame 500 had a predefined height (SCREEN_HEIGHT 504) and width (SCREEN_WIDTH 502), the first window 510 is characterized by its predefined height 514 and width 516 and the second window 520 is characterized by its predefined height 524 and width 526. Each window is refreshed by image data from a single access channel.

The five access channels that are supported by the ADC 260 can be divided to two types. The first type includes retrieving image data captured from camera 300, whereas the image frames are provided at a predetermined update rate Ur. The second type includes retrieving image frames, for example during video playback, from a memory at a manner that is wholly controlled by the IPU 200. According to another embodiment of the invention image frames that are provided by camera 300 or a memory bank can also be filtered by filter 430 before being provided to ADC 260.

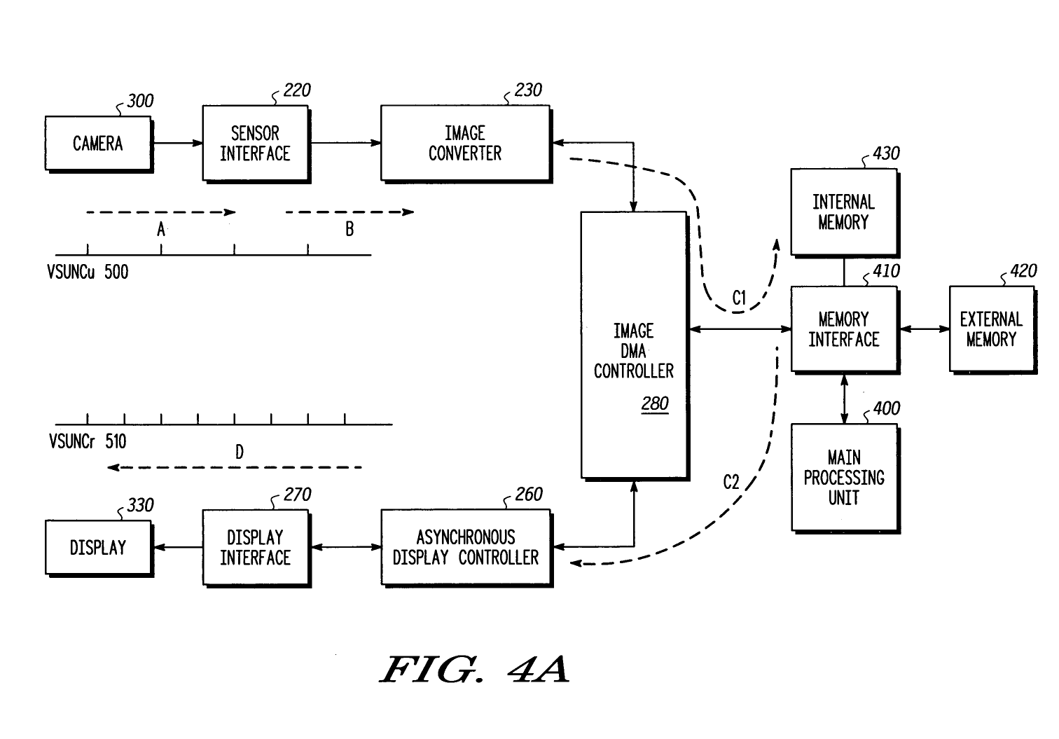

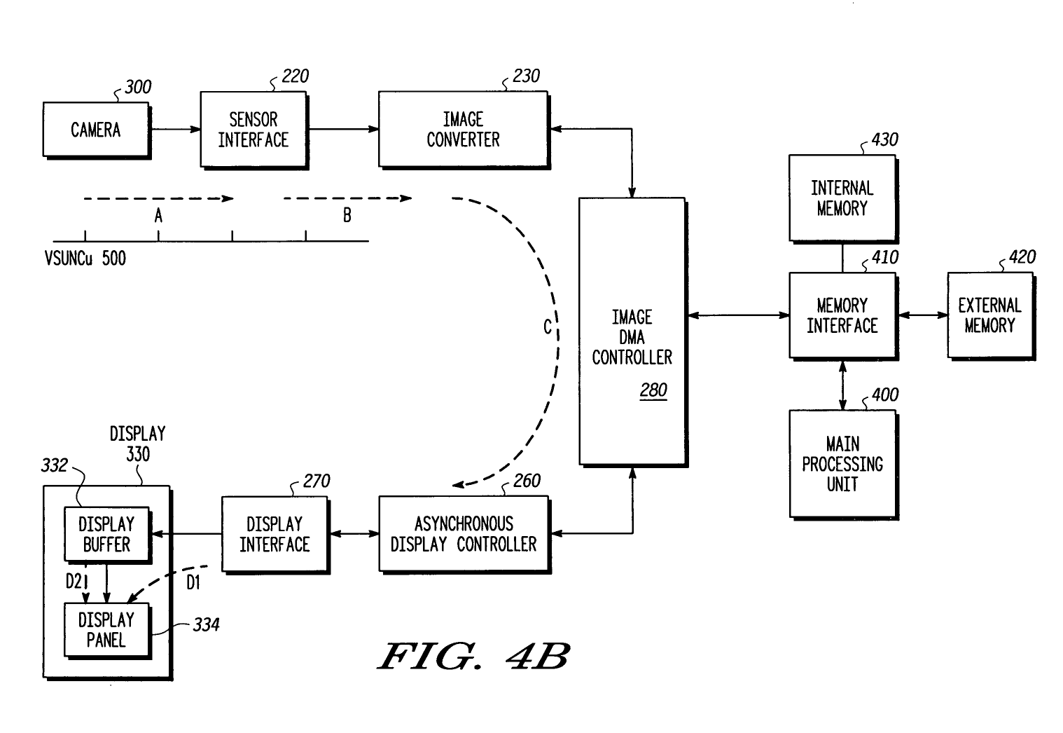

FIG. 4a illustrates a first type access channel according to an embodiment of the invention. Multiple components and buses were further omitted for simplicity of explanation. The access channel includes receiving image frames at sensor interface 220 (denoted A); sending the image data to image converter 230 (denoted B), in which the image data can be preprocessed or remain unchanged; providing the image data via IDMAC 280 to a memory bank (denoted C1), retrieving the image data from the memory bank to ADC 260 (denoted C2); and finally providing the image data to display 330 via display interface 270 (denoted D). If the display does not include a frame buffer the IPU 200 provides N+1 image frames for each N image frames captured by the image sensor. FIG. 4a also illustrates two sequences of synchronization signals VSYNCu 500 and VSYNCr 510. It is noted that the sequence of VSYNCu 500 is characterized by an update rate Ur, the sequence of VSYNCr 510 is characterized by refresh rate Rr and that Ur/Rr=(N+1)/N. Each synchronization signal synchronized the writing or reading of an image frame.

FIG. 4b illustrates a second type of access channel that is adapted to provide image frames to a display 330 that includes a display panel 334 as well as an internal buffer 332. The IPU 200 provides the display 330 sequences of N image frames that are accompanied by N+1 synchronization signals. The display panel 334 displays images provided from IPU (denoted D1) and also images stored at the internal buffer 332 (denoted D2).

It is noted that as the refresh rate Rr is higher than the update rate Ur an image frame that is stored at a frame buffer can be read more than once before the content of the frame buffer is updated.

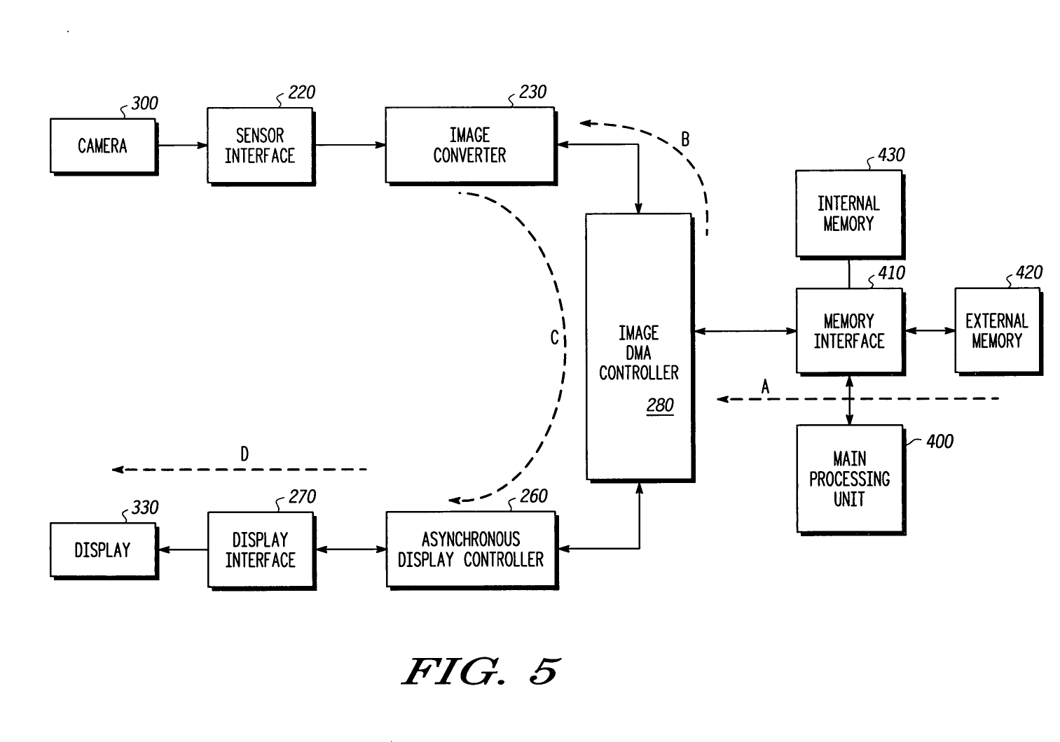

FIG. 5 illustrates a third type access channel, according to an embodiment of the invention. Multiple components and buses were further omitted for simplicity of explanation. This access channel includes retrieving image frames from an external memory 420 to IDMAC 280 (denoted A); sending the image data to image converter 230 (denoted B), in which the image data is post-processed; providing the image data via IDMAC 280 to ADC 260 (denoted C); and finally providing the image data to display 330 via display interface 270 (denoted D).

The third type access channel can prevent tearing by the double buffering method in which a first buffer is utilized for writing image data while the second buffer is utilized for reading image data, whereas the roles of the buffers alternate. It is noted that the image frames that are sent to ADC 260 can originate from the camera 300. Thus, prior to stage A of FIG. 5, preliminary stages such as capturing the image frames by the sensor interface 220, passing them to the IDMAC 280 (with or without preprocessing by image converter 230), and sending them to a memory such as internal or external memory 430 and 420.

Conveniently, ADC 260 prevents tearing of images retrieved from a memory module (such as memory modules 420 and 430) or after being post-processed by image converter 230 by controlling an update pointer in response to the position of a display refresh pointer. The display refresh pointer points to image data (stored within a frame buffer) that is sent to the display, while the update pointer points to an area of the frame buffer that receives image data from the memory module. Image data is read from the frame buffer only after the display refresh pointer crosses a window start point. Till the end of the frame the update pointer is not allowed to advance beyond the refresh pointer.

When retrieving data from memory to smart displays the IPU 200 can allow snooping in order to limit the amount of access to the memory and the amount of writing operations to a smart display. A smart display has a buffer and is capable of refreshing itself. Only if a current image frame differs from a previous image frame then the current image frame is sent to the display. System 10 may include means (usually dedicated hardware) to perform the comparison. The result of the comparison is sent to the IPU 200 that can decide to send updated image data to a display or if necessary, to send an appropriate interrupt to the main processing unit 400. IPU 200 can also monitor the output of said means in a periodical manner to determine if updated image data has been received.

The display of image frames retrieved from camera 300 and sent to the display either directly or after being preprocessed, is more complex. This complexity results from the rigid update cycle that occurs at an update rate Ur. The update cycle can be dictated by the vendor of the camera 300 or other image source.

The inventors found that if a ratio of (N+1)/N is maintained between the refresh rate of the display Rr and the update rate Ur than tearing can be prevented by using a single buffer instead of a double buffer. Conveniently N=1 but this is not necessarily so.

Conveniently, each N update cycles an update cycle starts at substantially the same time as a corresponding refresh cycle.

The single buffer can be included within the display or form a part of system 10.

The refresh cycle and the update cycles can be synchronized to each other by synchronization signals that are derived from each other. For example, assuming that the refresh process is synchronized by a vertical synchronization signal VSYNCu then IPU 200 can generate a corresponding VSYNCr signal that synchronizes the refresh process. This generation is performed by asynchronous display adapted 267 that can apply various well-known methods for generating VSYNCr.

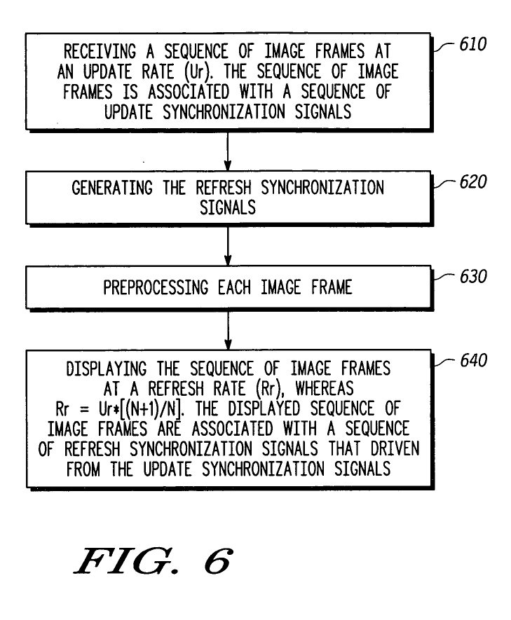

FIG. 6 illustrates a method 600 for displaying a sequence of image frames, according to an embodiment of the invention.

Method 600 starts by stage 610 of receiving a sequence of image frames at an update rate (Ur). The sequence of image frames is associated with a sequence of update synchronization signals.

]. Stage 610 is followed by stage 640 of displaying the sequence of image frames at a refresh rate (Rr), whereas Rr=Ur*[(N+1)/N]. The displayed sequence of image frames are associated with a sequence of refresh synchronization signals that driven from the update synchronization signals.

Conveniently, an N'th update synchronization signal and an (N+1)'th refresh synchronization signal are generated substantially simultaneously. There is substantially no phase difference between the beginning of a sequence of N update cycles and a beginning of a sequence of N+1 refresh cycles.

Conveniently, stage 610 includes receiving the sequence of update synchronization signals and stage 610 is followed by stage 620 of generating the refresh synchronization signals.

Conveniently, stage 610 includes writing each image frame to a frame buffer and whereas the stage of displaying comprising retrieving the image from the frame buffer. The frame buffer can be included within the display or within the system on chip 10.

According to another embodiment of the invention method 600 further includes stage 630 of preprocessing each image frame. Stage 630 is illustrated as following stage 620 and preceding stage 640.

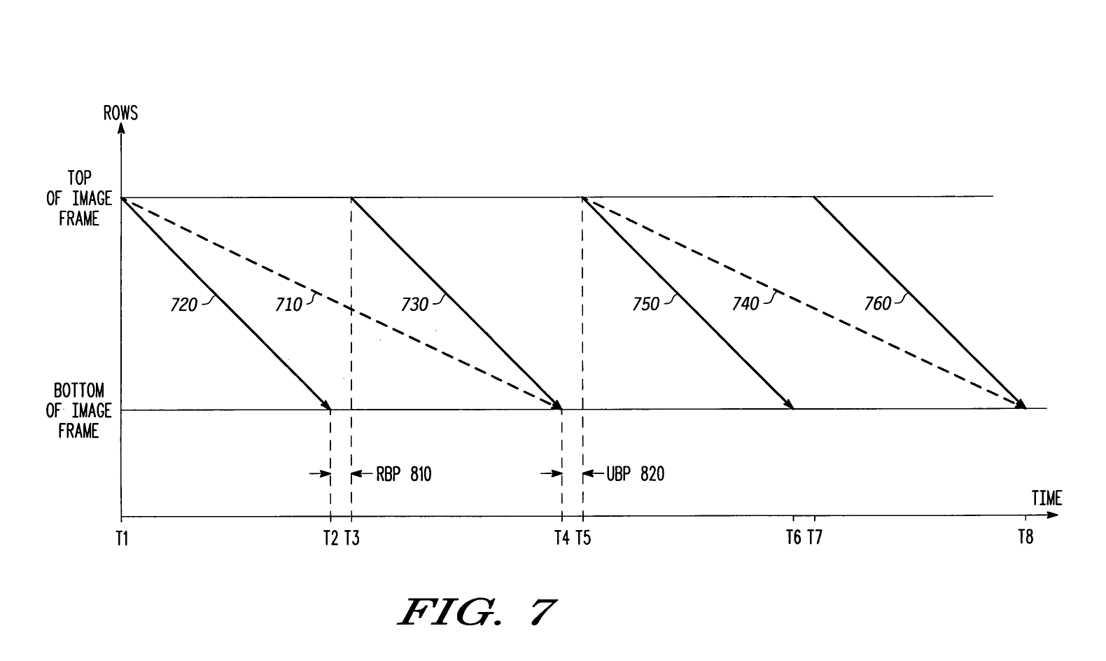

FIG. 7 is a timing diagram 700 that illustrating the progress of image frame updates and refresh processes where N=1, according to an embodiment of the invention.

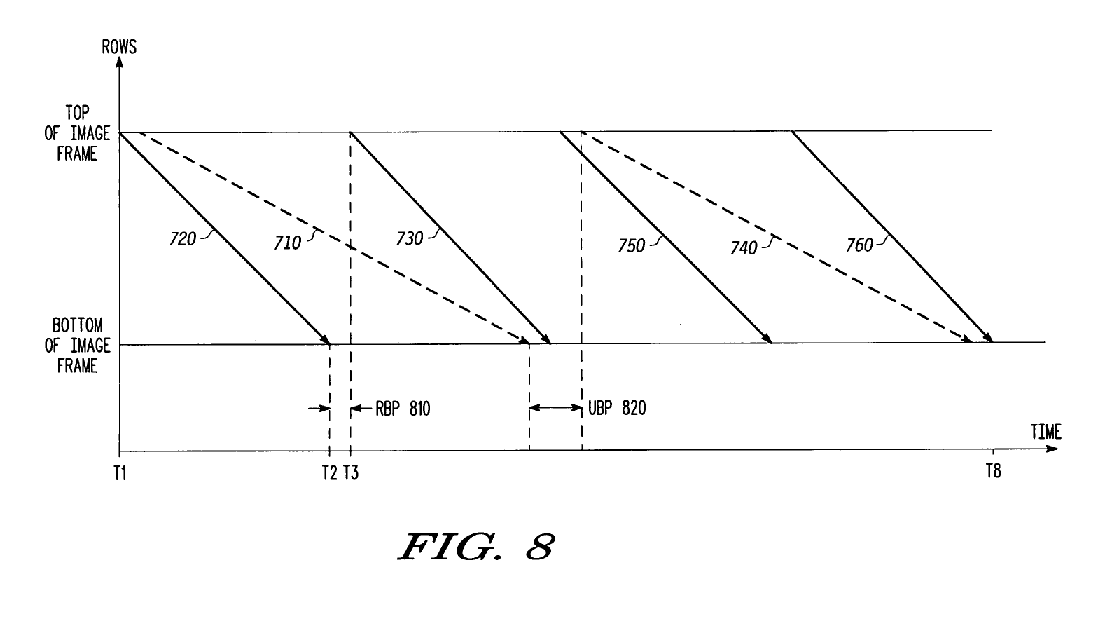

The timing diagram 700 illustrates two image frame update cycles and four image frame refresh cycles. For simplicity of explanation it is assumed that a refresh blanking period and an update blanking period are the same and that each image update cycle starts when a certain image refresh cycle starts and ends when another image refresh cycle ends, but this is not necessarily so. FIG. 8 illustrates a timing diagram in which the image update cycle starts after a first image refresh cycle starts and ends before another image refresh cycle ends.

The first image update cycle (illustrated by a sloped line 710) starts at T1 and ends at T4. The first image refresh cycle (illustrated by dashed sloped line 720) starts at T1 and ends at T2. A second image refresh cycle (illustrated by dashed sloped line 730) starts at T3 and ends at T4. The time period between T2 and T3 is defined as a refresh blanking period RBP 810. The refresh rate Rr equals 1/(T3-T1).

The second image update cycle (illustrated by a sloped line 740) starts at T5 and ends at T8. The third image refresh cycle (illustrated by dashed sloped line 750) starts at T5 and ends at T6. A fourth image refresh cycle (illustrated by dashed sloped line 760) starts at T7 and ends at T8. The time period between T4 and T5 is defined as an update blanking period UBP 820. The update rate Ur equals 1/(T5-T1).

Referring back to FIG. 2, the output and input data bus of the display interface 270 can be 18-bit wide (although narrower buses can be used) and it conveniently can transfer pixels of up to 24-bit color depth. Each pixel can be transferred during 1, 2 or 3 bus cycles and the mapping of the pixel data to the data bus is fully configurable. For output to a TV encoder, a YUV 4:2:2 format is supported. Additional formats can be supported by considering them as “generic data”—they are transferred—byte-by-byte, without modification—from the system memory to the display.

The display interface 270 conveniently does not include an address bus and it's asynchronous interface utilizes “indirect addressing” that includes embedding address (and related commands) within a data stream. This method was adapted by display vendors to reduce the number of pins and wires between the display and the host processor.

Some software running on the main processing unit 400 is adapted to a direct address operation mode in which a dedicated bus is utilized for sending addresses. Thus, when executing this type of software the main processing unit cannot manage indirect address displays. System 10 provides a translation mechanism that allows the main processing unit 400 to execute direct address software while managing indirect address displays.

Indirect addressing is not standardized yet. In order to support many possible indirect addressing formats the IPU 200 is provided with a “template” specifying the access protocol to the display device. The template is stored within template memory 238. The IPU 200 uses this template to access display 330 without any further main processing unit 400 intervention. The “template” or map can be downloaded during a configuration stage, but this is not necessarily so.

In particular, software running on the main processing unit 400 can request an access to the display 330, the ADC 260 captures the request (through the interface 261) and performs the appropriate access procedure.

It is noted that the above description relates to vertical synchronization signals (such as VSYNCr and VSYNCu), but that the synchronization signals also include other signals such as horizontal synchronization signals.

The main pixel formats supported by sensor interface are YUV (4:4:4 or 4:2:2) and RGB. It is noted that other formats (such as Bayer or JPEG formats, as well as formats that allocate a different amount of bits per pixel) can be received as “generic data”, which is transferred, without modification, to the internal or external memory 420 and 430. IPU 200 also supports arbitrary pixel packing. The arbitrary pixel packing scheme allows to change an amount of bits allocated for each of the three color components as well as their relative location within the pixel representation.

The synchronization signals from the sensor are either embedded in the data stream (for example in a BT.656 protocol compliant manner) or transferred through dedicated pins.

The IDMAC 280 is capable of supporting various pixel formats. Typical supported formats are: (i) YUV: interleaved and non-interleaved, 4:4:4, 4:2:2 and 4:2:0, 8 bits/sample; and (ii) RGB: 8, 16, 24, 32 bits/pixel (possibly including some non-used bits), with fully configurable size and location for each color component, and additional component for transparency is also supported.

Filtering and rotation are performed by the IPU 200 while reading (and writing) two-dimensional blocks from (to) memory 420. The other tasks are performed row-by-row and, therefore, can be performed on the way from the sensor and/or to the display.

In many devices, most of the components are idle for prolonged time periods, while the screen has to be refreshed periodically. The IPU 200 can perform screen refreshing in an efficient and low energy consuming manner. The IPU 200 can also provide information to smart displays without substantially requiring the main processing unit 400 to participate. The participation may be required when a frame buffer is updated.

The IPU 200 is further capable of facilitating automatic display of a changing/moving image. In various scenarios, for example, when the system 10 is idle, a sequence of changing image can be displayed on display 330. The IPU 200 provides a mechanism to perform this with minimal main processing unit 400 involvement. The main processing unit 400 stores in memory 420 and 430 all the data to be displayed, and the IPU 200 performs the periodic display update automatically. For an animation, there would be a sequence of distinct frames, and for a running message, there would be a single large frame, from which the IPU 200 would read a “running” window. During this display update, the main processing unit 400 can be operated in a low energy consumption mode. When the IPU 200 reaches the last programmed frame, it can perform one of the following: return to the first frame—in this case, the main processing unit 400 can stay powered down; or interrupt the main processing unit 400 to generate the next frames.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

We claim

1. A method for displaying a sequence of image frames, the method comprises:
receiving a sequence of image frames at an update rate Ur), the sequence of image frames is associated with a sequence of update synchronization signals; and
displaying the sequence of images at a refresh rate (Rr), whereas Rr=Ur*[(N+1)/N]; whereas the sequence of images are associated with a sequence of refresh synchronization signals that driven from the update synchronization signals.

2. The method of claim 1 wherein an N'th update synchronization signal and an (N+1)'th refresh synchronization signal are generated substantially simultaneously.

3. The method of claim 1 wherein the method comprised a stage of receiving the sequence of update synchronization signals and generating the refresh synchronization signals.

4. The method of claim 1 wherein the stage of receiving comprises writing each image frame to a frame buffer and whereas the stage of displaying comprising retrieving the image from the frame buffer.

5. The method of claim 1 wherein the stage of receiving comprises sending each image frame to a display comprising a frame buffer and the stage of displaying comprises providing the refresh synchronization to the display.

6. The method of claim 1 wherein the stage of receiving comprises receiving the sequence of update synchronization signals.

7. The method of claim 1 further comprising preprocessing each image frame before displaying that image frame.

8. The method of claim 1 whereas the stage of receiving comprises receiving the sequence of image frames from an image sensor.

9. The method of claim 1 whereas the stage of receiving comprises retrieving the sequence of image frames from an image buffer.

10. The method of claim 1 whereas the stage of receiving comprising receiving the sequence of image frames at a image processing unit.

11. A system for displaying a sequence of image frames, the system comprises:
a first circuitry, adapted to receive a sequence of image frames at an update rate (Ur), the sequence of image frames is associated with a sequence of update synchronization signals;
a second circuitry, adapted to control a display the sequence of images at a refresh rate (Rr), whereas Rr=Ur*[(N+1)/N]; whereas the sequence of images are associated with a sequence of refresh synchronization signals that driven from the update synchronization signals.

12. The system of claim 11 adapted to generate an N'th update synchronization signal and an (N+1)'th refresh synchronization signal substantially simultaneously.

13. The system of claim 11 adapted to receive the sequence of update synchronization signals and generate the refresh synchronization signals.

14. The system of claim 11 wherein system comprises a frame buffer facilitating reading and writing a image frame.

15. The system of claim 11 wherein the second circuitry is adapted to send each image frame to a display comprising a frame buffer and to provide the refresh synchronization to the display.

16. The system of claim 11 adapted to receive receiving the sequence of update synchronization signals.

17. The system of claim 11 further comprising an image converter, coupled to the first circuitry, for preprocessing each image frame before displaying that image frame.

18. The system of claim 11 whereas the first circuitry is adapted to receive the sequence of image frames from an image sensor.

19. The system of claim 11 whereas the first circuitry is adapted to retrieve the sequence of image frames from an image buffer.
